(19) United States
(12) Patent Application Publication
(10) Pub. No.: US 2006/0008677 A1
(43) Pub. Date: Jan. 12, 2006

(54) Ceramic bonding composition, method of making, and article of manufacture incorporating the same

(75) Inventors: Bernard Patrick Bewlay, Schenectady, NY (US); James Scott Vartuli, Rexford, NY (US); James Anthony Brewer, Scotia, NY (US)

Correspondence Address: General Electric Company;CRD Patent Docket Rm 4A59, P.O. Box 8, Bldg. K-1, Schenectady, NY, 12301, US

(73) Assignee: General Electric Company

(21) Appl. No.: 10/888,852

(22) Filed: Jul. 12, 2004

(51) Int. Cl. C03C 3/095; C03B 29/00; B32B 15/04; B32B 19/00

(52) U.S. Cl. 428/702; 156/89.11; 501/64; 428/701; 428/469

(57) ABSTRACT

A ceramic bonding composition comprises a first oxide and at least a second oxide having a formula of Me₂O₃; wherein the first oxide is selected from the group consisting of aluminum oxide, scandium oxide, and combinations thereof; Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof. The ceramic bonding composition can further comprise silica. An article of manufacture comprising at least two members attached together with the ceramic bonding composition.

### BACKGROUND OF THE INVENTION

The invention generally relates to a ceramic bonding composition for bonding ceramic components or ceramic-metal components to other ceramic components, metallic components or ceramic-metal components, and a method of making the ceramic bonding composition. More particularly, the invention relates to a ceramic bonding composition for ceramic envelopes for high temperature lamp applications.

High intensity discharge lamps, such as projection lamps, automotive lamps, high pressure sodium lamps, and ceramic metal halide lamps are often formed from a ceramic envelope known in the art as an “arc tube”. The ceramic envelope is bonded or sealed to one or more end caps by using a bonding or a sealing composition often referred to as a “seal glass”, which has physical and mechanical properties approximately matching those of the ceramic envelope. High temperature operations of these lamps give rise to various stresses primarily because of the differences of the coefficients of thermal expansion between the sealed components and the seal composition. These stresses can lead to residual stresses and ceramic bonding cracks causing failure of the lamp. This type of failure is a particular problem for high-pressure lamps.

At the elevated temperatures and pressures used in high intensity discharge lamps, the sealing composition must have a coefficient of thermal expansion very close to that of the ceramic envelope material, and must also be able to withstand the high operating temperatures of these lamps. Elevated operating temperature improves efficiency and the color rendering properties of these lamps. Sealing compositions such as alumina-niobia, titania-nickel oxide, alumina-calcia-magnesia, alumina-calcia-silica-magnesia-baria oxide, and alumina-calcia-silica have been developed for lamp applications. However, these sealing compositions cannot withstand sustained operating temperature above 950° C.

Accordingly, a ceramic bonding composition that can withstand high operating temperatures, and that has a coefficient of thermal expansion that can closely match the coefficient of thermal expansion of the other high intensity lamp components is needed. It would also be desirable to provide a method for making such a high temperature ceramic bonding composition

### BRIEF DESCRIPTION OF THE INVENTION

A first aspect of the present invention provides a ceramic bonding composition comprising alumina and at least another oxide having a formula of Me₂O₃; wherein Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein when Me is other than lanthanum, an amount of the at least another oxide in the ceramic bonding composition satisfies a condition selected from the group consisting of: (a) when Me is selected from the group consisting of yttrium, dysprosium, holmium, erbium, thulium, ytterbium, lutetium, and combinations thereof, the amount is between about 3 and about 15 mole percent, or between 25 and about 37.5 mole percent; and (b) when Me is selected from the group consisting of neodymium, samarium, gadolinium, europium, praseodymium, terbium, and combinations thereof, the amount is between about 3 and about 18 mole percent, or between 28 and about 37.5 mole percent.

Another aspect of the present invention provides a ceramic bonding composition comprising a first oxide, at least a second oxide having a formula of Me₂O₃, and silica; wherein the first oxide is selected from the group consisting of aluminum oxide, scandium oxide, and combinations thereof; Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein the ceramic bonding composition satisfies a condition selected from the group consisting of: (a) the ceramic bonding composition comprising the first oxide in an amount between about 25 and about 55 weight percent, silica in an amount greater than about 45 weight percent, and Me₂O₃ in an amount less than about 30 weight percent; (b) the ceramic bonding composition comprising the first oxide in an amount between about 25 and about 90 weight percent, silica in an amount less than about 45 weight percent, and Me₂O₃ in an amount less than about 20 weight percent; (c) the ceramic bonding composition comprising the first oxide in an amount between about 55 and about 80 weight percent, silica in an amount less than about 30 weight percent, and Me₂O₃ in an amount between about 20 and 55 weight percent; and (d) the ceramic bonding composition comprising the first oxide in an amount between about 25 and about 55 weight percent, silica in an amount less than about 5 weight percent, and Me₂O₃ in an amount between about 55 and about 70 weight percent.

Yet another aspect of the present invention provides a ceramic bonding composition comprising a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the oxides form substantially a garnet crystal structure.

Yet another aspect of the present invention provides a ceramic bonding composition comprising a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the ceramic bonding composition is in a range from a eutectic composition to a garnet composition.

Still another aspect of the present invention provides an article of manufacture comprising the ceramic bonding composition of the present invention, wherein at least two members of the articles are bonded together with a ceramic bonding composition.

Still another aspect of the present invention provides a method for bonding together a first work piece and a second work piece by using the ceramic bonding composition of the present invention, the method comprising: (a) providing the ceramic bonding composition of the present invention; (b) disposing the ceramic bonding composition between a portion of the first work piece and another portion of the second work piece to form an assembly; and (c) heating the assembly at a predetermined temperature for a predetermine time to bond the first work piece and the second work piece together.

These and other aspects, advantages, and salient features of the present invention will become apparent from the following detailed description, the accompanying drawings, and the appended claims.

### BRIEF DESCRIPTION OF THE DRAWINGS

FIG. 1 is a diagrammatic overview of an exemplary high intensity discharge lamp according to aspects of the present invention;

FIG. 2 is a diagrammatic representation of an exemplary ceramic envelope of FIG. 1 coupled to end cap using a ceramic bonding composition;

FIG. 3 is an illustration of an alumina-yttria binary phase diagram; and

FIG. 4 is an illustration of an alumina-dysprosia binary phase diagram.

### DETAILED DESCRIPTION OF THE INVENTION

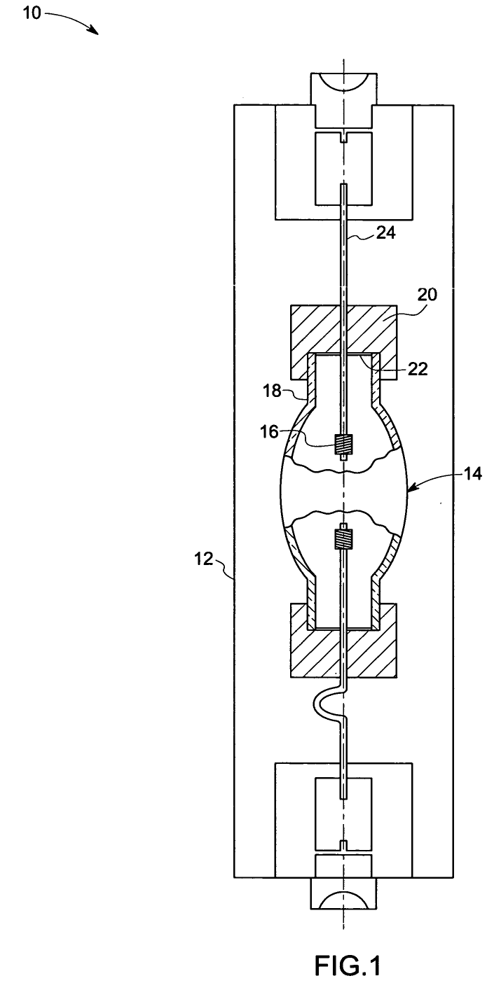

Referring to the drawings in general, it will be understood that the illustrations are for the purpose of describing different embodiments of the invention, and are not intended to limit the invention thereto. Turning to FIG. 1, it is a diagrammatic overview of an exemplary high intensity discharge lamp according to aspects of the present invention. The lamp 10 has an outer cylindrical envelope 12 with ceramic envelope 14 disposed inside. Two metal electrodes 16 are placed inside the ceramic envelope 14 from two end portions 18 of the ceramic envelope 14. End portions 18 of the ceramic envelope 14 are enclosed using an end cap 20 being made of a ceramic metal composite. In some embodiments, an insulating coating 22 of a refractory oxide such as alumina is applied on the end cap. The insulating coating 22 protects the ceramic composite of the end cap from reacting with plasma and forming an arc. The ceramic envelope 14 further comprises a feedthrough 24, which passes through an opening in the end cap 20. Feedthrough 24 is generally made of, metals, such as but not limited to, molybdenum, tungsten, and niobium.

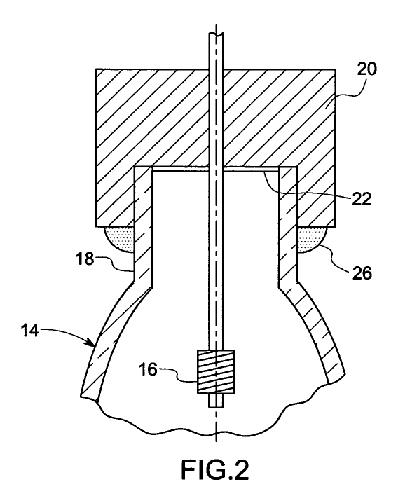

FIG. 2 is a diagrammatic representation of an exemplary ceramic envelope 14 of FIG. 1 coupled to end cap 20 using a ceramic bonding composition 26. Ceramic envelope 14 is usually made of a ceramic material such as yttrium-aluminum-garnet, ytterbium-aluminum-garnet, micro-grain polycrystalline alumina, polycrystalline alumina, or yttria. Ceramic envelope 14 comprises a fill material of light emitting materials such as sodium and rare earths (e.g., scandium, indium, dysprosium, neodymium, cerium, and thorium) usually in the form of a halide, optionally mercury halide, and, optionally, an inert gas such as krypton, argon or xenon. Further, the fill material emits a desired spectral energy distribution in response to being excited by the electric arc produced by the two electrodes 16. A ceramic bonding composition 26 is used to seal or bond the end cap 20 to the ceramic envelope 14. Ceramic bonding composition 26 may also be used at the other joints and junctions in the lamp 10, e.g., the ceramic bonding composition 26 may be used to seal the electrode 16, or the feedthrough 24 to the end cap 20. The ceramic envelope 14 is usually made to operate at higher temperatures, e.g., above 950° C. Due to high temperatures involved in the operation of ceramic envelope lamps, it is very important that the ceramic envelope materials and the ceramic bonding composition 26 have compatible coefficients of thermal expansion. This prevents occurrence of cracks in ceramic bonding composition 26, resulting from residual stresses at elevated temperatures, which is one of the major reasons of failure of ceramic lamps. In one embodiment of the invention, ceramic bonding compositions 26 having coefficients of thermal expansion compatible with the coefficients of thermal expansion of the ceramic envelope materials are suitable for such high temperature applications.

According to one aspect of the present invention, a ceramic bonding composition 26 comprises alumina and at least another oxide having a formula of Me₂O₃; wherein Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof. When Me is other than lanthanum, an amount of the at least another oxide in the ceramic bonding composition satisfies a condition which is selected from the group consisting of (a) when Me is selected from the group consisting of yttrium, dysprosium, holmium, erbium, thulium, ytterbium, lutetium, and combinations thereof, the amount is between about 3 and about 15 mole percent, or between 25 and about 37.5 mole percent; and (b) when Me is selected from the group consisting of neodymium, samarium, gadolinium, europium, praseodymium, terbium, and combinations thereof, the amount is between about 3 and about 18 mole percent, or between 28 and about 37.5 mole percent. In one embodiment, Me is yttrium. In another embodiment, Me is dysprosium. In yet another embodiment, Me is a combination of yttrium and dysprosium.

In one embodiment, the amount of another oxide in the ceramic bonding composition 26 satisfies a condition selected from the group consisting of (a) when Me is selected from the group consisting of yttrium, dysprosium, holmium, erbium, thulium, ytterbium, lutetium, and combinations thereof, the amount is between about 25 and about 37.5 mole percent; and (b) when Me is selected from the group consisting of neodymium, samarium, gadolinium, europium, praseodymium, terbium, and combinations thereof, the amount is between 28 and about 37.5 mole percent.

According to another aspect of the present invention, the ceramic bonding composition 26 comprises a first oxide, at least a second oxide having a formula of Me₂O₃, and silica; wherein the first oxide is selected from the group consisting of aluminum oxide, scandium oxide, and combinations thereof; Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof. Further, the ceramic bonding composition satisfies a condition selected from the group consisting of (a) the ceramic bonding composition comprising the first oxide in an amount between about 25 and about 55 weight percent, silica in an amount greater than about 45 weight percent, and Me₂O₃ in an amount less than about 30 weight percent; (b) the ceramic bonding composition comprising the first oxide in an amount between about 25 and about 90 weight percent, silica in an amount less than about 45 weight percent, and Me₂O₃ in an amount less than about 20 weight percent; (c) the ceramic bonding composition comprising the first oxide in an amount between about 55 and about 80 weight percent, silica in an amount less than about 30 weight percent, and Me₂O₃ in an amount between about 20 and 55 weight percent; and (d) the ceramic bonding composition comprising the first oxide in an amount between about 25 and about 55 weight percent, silica in an amount less than about 5 weight percent, and Me₂O₃ in an amount between about 55 and about 70 weight percent.

In general, silica is used to reduce the melting temperature of the ceramic bonding composition. However, use of large amounts of silica may also lead to glass formation in the seal, which is undesirable. Secondly, addition of silica also reduces the operating temperature of the ceramic bonding composition 26, hence a large amount of silica is not desirable. Thirdly, addition of silica reduces the coefficient of thermal expansion of the ceramic bonding composition 26, which may lead to thermal mismatch and, thereby to ceramic bonding cracks. Hence, the amount of silica in the ceramic bonding composition 26 is kept below a certain level.

In one embodiment, Me is yttrium. In another embodiment, Me is dysprosium. In yet another embodiment, Me is a combination of yttrium and dysprosium.

In another aspect of the present invention, ceramic bonding composition comprising 26 comprises a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the oxides form substantially a garnet crystal structure. In general, garnet is represented by a chemical formula A₃B₅O₁₂, where A is a large ion, mainly from the Group-3 metals and rare-earth metal series, and B is relatively small ion from the lanthanide series, alkaline earth metal series, and other smaller ions like aluminum, chromium, iron and the like. Garnet crystal structure has three different types of lattice sites, dodecahedral, octahedral, and tetrahedral, for possible occupation by ions. Further, the number of dodecahedral, octahedral and tetrahedral sites in the garnet crystal structure is 3, 3, and 2, respectively. Dodecahedral site accepts large ions, whereas, octahedral and tetrahedral sites accept smaller ions. Thus, the garnet crystal structure presents numerous possibilities for the sites to be filled by different ions.

In one embodiment, the ceramic bonding composition comprises up to about 30 mole percent of silica. In another embodiment, the ceramic bonding composition comprises up to about 10 mole percent of silica.

In one embodiment, Mc is aluminum. In one embodiment, Me is yttrium. In one embodiment, the amount of alumina and yttria is such that the ceramic bonding composition comprises a mixture of alumina and yttrium aluminum garnet commonly known as YAG and having the chemical formula Y₃Al₅O₁₂. In another embodiment, Me is dysprosium. Further, the amount of alumina and dysprosium is such that the ceramic bonding composition comprises a mixture of alumina and dysprosium aluminum garnet, commonly known as DAG and having the chemical formula, Dy₃Al₅O₁₂, and commonly known as DAG. In another embodiment, Me is a combination of dysprosium and yttrium.

In another aspect of the present invention, a ceramic bonding composition comprises a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the ceramic bonding composition is in a range from a eutectic composition to a garnet composition.

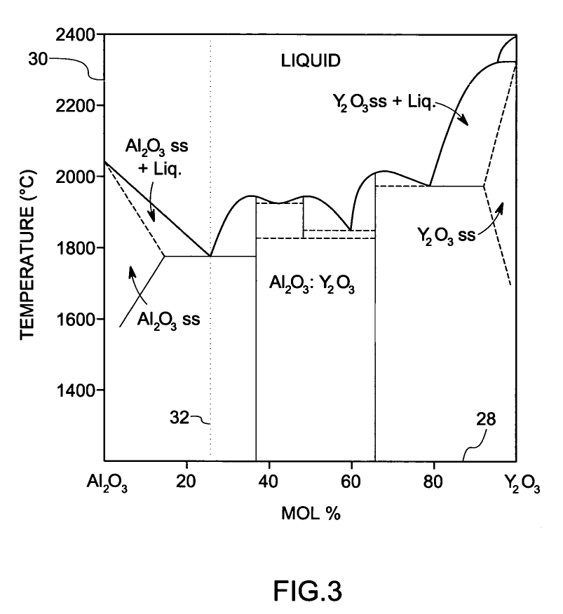

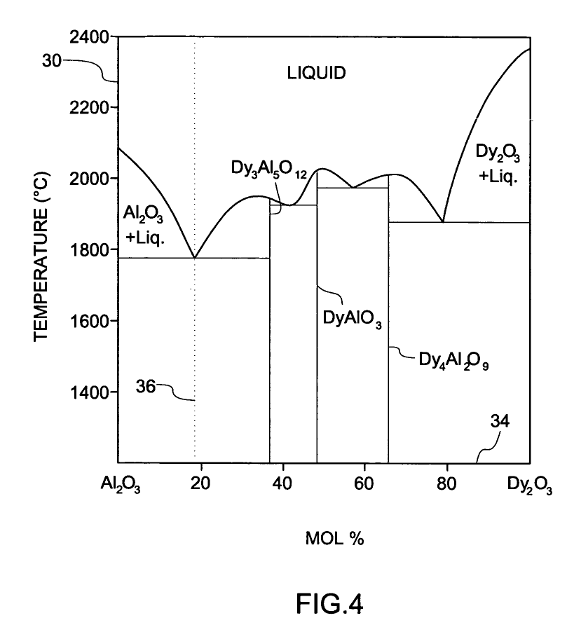

In one embodiment, Mc is aluminum. In one specific embodiment, the total amount of alumina in the ceramic bonding composition is in a range from about 1 mole percent to about 50 mole percent. In one embodiment, Me is yttrium. In one embodiment, the amount of alumina and yttria is such that the ceramic bonding composition comprises a mixture of alumina and yttrium aluminum garnet commonly known as YAG and having the chemical formula Y₃Al₅O₁₂. In one embodiment, the eutectic composition is the first eutectic composition in the alumina rich region. FIG. 3 is an illustration of an alumina-yttria binary phase diagram, showing several eutectics in this system. Abscissa 28 represents increasing mole percent of yttria from the left to the right. Ordinate 30 represents the temperature in ° C. In another embodiment, Me is dysprosium. Further, the amount of alumina and dysprosium is such that the ceramic bonding composition comprises a mixture of alumina and dysprosium aluminum garnet, commonly known as DAG and having the chemical formula, Dy₃Al₅O₁₂, and commonly known as DAG. In another embodiment, Me is a combination of dysprosium and yttrium. The first eutectic composition on alumina rich side occurs at composition represented by the line 32. In one embodiment, the eutectic composition is the first eutectic composition in the dysprosia rich region. FIG. 4 is an illustration of an alumina-dysprosia binary phase diagram, showing several eutectics in this system. Abscissa 34 represents increasing mole percent of dysprosia from left to right. Ordinate 30 represents the temperature in ° C. The first eutectic composition on alumina rich side occurs at composition represented by the line 36. In one embodiment, Me is a combination of dysprosium and yttrium.

In another aspect of the invention, a method for bonding a first work piece and a second work piece by using the ceramic bonding composition 26 is provided. In a one embodiment, the first work piece is the ceramic envelope 14, and the second work piece is the end cap 20. The method as described hereinabove comprises providing the ceramic bonding composition 26 as described earlier.

The ceramic bonding composition is produced by means known in the art, such as, but not limited to, sol-gel route, and milling. Sol-gel route generally refers to a low temperature method using chemical precursors that can produce ceramics with better purity and homogeneity than high temperature conventional processes. In general, sol-gel route involves the transition of a system from a liquid “sol” into a solid “gel” phase. In a typical sol-gel route, the precursor is subjected to a series of reactions to form a colloidal suspension, or a “sol” phase. Further processing of the “sol” enables formation of ceramic materials in different forms, such as powder, mold, or thin film. In one embodiment, alcohol based milling was used to mix the precursors. Typically, alcohol based milling comprises forming a solution by mixing the precursors with an alcohol, such as, but not limited to ethanol, and subjecting the solution to milling. In one embodiment, the alcohol based milling is done without using grinding media.

The ceramic bonding composition 26 so obtained is processed using methods, such as, but not limited to, pressing, or forming a slurry. In one embodiment, pressing is done by means such as, but not limited to, isostatic pressing. In one embodiment, the ceramic bonding composition 26 is spray dried before pressing it to form a pellet or an annular ring. In another embodiment, a slurry is formed by mixing the ceramic bonding composition 26 in a solvent. In a particular embodiment, the slurry of the ceramic bonding composition 26 is made in an alcohol medium, for example, ethanol.

After processing the ceramic bonding composition is disposed between a portion of the first work piece and another portion of the second work piece to form an assembly. In one embodiment, the ceramic envelope 14 is placed axially symmetric to the end cap 20 and sealed using the ceramic bonding composition 26 to form the assembly. In one embodiment, the ceramic bonding composition 26 in the form of a slurry is applied around the ceramic envelope 14, and adjacent to the end cap 20 as shown in FIG. 2. In another embodiment, the ceramic bonding composition 26 in the form of an annular ring is disposed around the ceramic envelope 14, and adjacent to the end cap 20.

The assembly so formed is heated at a predetermined temperature for a predetermined time to bond the first piece and the second work piece together. The predetermined temperature is such that the ceramic bonding composition substantially melts. In one embodiment, the heating is directed at a joint between the first and the second work piece at which the ceramic bonding composition is disposed. In one embodiment, the predetermined temperature is in a range from about 1500° C. to about 1900° C. In one embodiment, the step of heating is effected by heat source such as, but not limited to, laser beam or radio frequency waves. The ceramic bonding composition 26 forms a melt as a result of heating. The assembly is cooled to room temperature to bond the first work piece and the second work piece.

In one embodiment, the assembly is heated in a non-oxidizing atmosphere. Non-oxidizing atmosphere is selected from a group consisting of argon, helium, neon, krypton, xenon, hydrogen, nitrogen, and mixtures thereof. In another embodiment, the assembly is heated in vacuum.

In another aspect of the invention, an article of manufacture comprises the ceramic bonding composition of the present invention. In one embodiment, the article of manufacture is a housing of a discharge lamp 10.

The following example illustrates the features of the invention, and is not intended to limit the invention in any way.

### EXAMPLE

A 50 grams batch of ceramic bonding composition comprising alumina and YAG was prepared. 64.4 wt % of alumina powder (Baikowsky CR10™, obtained from Alfa Aesar), and 35.6 wt % of yttria powder Starck™ (obtained from Alfa Aesar) was poured in to a plastic container. Further, alumina grinding media and ethanol were added into the plastic container. The mixture in the plastic container was subjected to ball milling for around 30 minutes to form the ceramic bonding composition.

Placing the assembly in an infrared oven for a period of about 30 minutes then dried the ceramic bonding composition. The dried ceramic bonding composition was then screened through a U.S. standard No 40 mesh to obtain a particle size not greater than 500 micrometers. The ceramic bonding composition so obtained was rolled to enhance agglomerate the ceramic bonding composition powder as agglomeration aids in packing.

Ethanol was mixed with the dried ceramic bonding composition to form a slurry. A ceramic envelope and an end cap were placed in an axially symmetric position to form an assembly. The slurry was applied at the junction of the ceramic envelope and the end cap, to seal the ceramic envelope. The assembly comprising the ceramic envelope, the end cap and the slurry of the ceramic bonding composition was heated to a temperature of about 1500° C. by means of a heating furnace in a hydrogen atmosphere. The assembly was held at the temperature for about 30 seconds to about 45 seconds, then the temperature of the assembly was brought down to room temperature to seal the ceramic envelope.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. A ceramic bonding composition comprising alumina and at least another oxide having a formula of Me₂O₃; wherein Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein when Me is other than lanthanum, an amount of the at least another oxide in the ceramic bonding composition satisfies a condition selected from the group consisting of:
(a) when Me is selected from the group consisting of yttrium, dysprosium, holmium, erbium, thulium, ytterbium, lutetium, and combinations thereof, said amount is between about 3 and about 15 mole percent, or between 25 and about 37.5 mole percent; and
(b) when Me is selected from the group consisting of neodymium, samarium, gadolinium, europium, praseodymium, terbium, and combinations thereof, said amount is between about 3 and about 18 mole percent, or between 28 and about 37.5 mole percent.

2. The ceramic bonding composition of claim 1, wherein Me is yttrium.

3. The ceramic bonding composition of claim 1, wherein Me is dysprosium.

4. The ceramic bonding composition of claim 1, wherein Me is a combination of yttrium and dysprosium.

5. The ceramic bonding composition of claim 1, wherein the amount of the at least another oxide in the ceramic bonding composition satisfies a condition selected from the group consisting of:
(a) when Me is selected from the group consisting of yttrium, dysprosium, holmium, erbium, thulium, ytterbium, lutetium, and combinations thereof, said amount is between about 25 and about 37.5 mole percent; and
(b) when Me is selected from the group consisting of neodymium, samarium, gadolinium, europium, praseodymium, terbium, and combinations thereof, said amount is between 28 and about 37.5 mole percent.

6. A ceramic bonding composition comprising a first oxide, at least a second oxide having a formula of Me₂O₃, and silica; wherein the first oxide is selected from the group consisting of aluminum oxide, scandium oxide, and combinations thereof; Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein the ceramic bonding composition satisfies a condition selected from the group consisting of:
(a) said ceramic bonding composition comprising the first oxide in an amount between about 25 and about 55 weight percent, silica in an amount greater than about 45 weight percent, and Me₂O₃ in an amount less than about 30 weight percent;
(b) said ceramic bonding composition comprising the first oxide in an amount between about 25 and about 90 weight percent, silica in an amount less than about 45 weight percent, and Me₂O₃ in an amount less than about 20 weight percent;
(c) said ceramic bonding composition comprising the first oxide in an amount between about 55 and about 80 weight percent, silica in an amount less than about 30 weight percent, and Me₂O₃ in an amount between about 20 and 55 weight percent; and
(d) said ceramic bonding composition comprising the first oxide in an amount between about 25 and about 55 weight percent, silica in an amount less than about 5 weight percent, and Me₂O₃ in an amount between about 55 and about 70 weight percent.

7. The ceramic bonding composition of claim 6, wherein Me is yttrium.

8. The ceramic bonding composition of claim 6, wherein Me is dysprosium.

9. The ceramic bonding composition of claim 6, wherein Me is a combination of yttrium and dysprosium.

10. A ceramic bonding composition comprising a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the oxides form substantially a garnet crystal structure.

11. The ceramic bonding composition of claim 10, wherein the ceramic bonding composition further comprises up to about 30 mole percent of silica.

12. The ceramic bonding composition of claim 11, wherein the ceramic bonding composition comprises up to about 10 mole percent silica.

13. The ceramic bonding composition of claim 10, wherein Mc is aluminum.

14. The ceramic bonding composition of claim 13, wherein Me is yttrium.

15. The ceramic bonding composition of claim 13, wherein Me is dysprosium.

16. The ceramic bonding composition of claim 13, wherein Me is a combination of yttrium and dysprosium.

17. A ceramic bonding composition comprising a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the ceramic bonding composition is in a range from a eutectic composition to a garnet composition.

18. The ceramic bonding composition of claim 17, wherein the ceramic bonding composition further comprises up to about 30 mole percent of silica.

19. The ceramic bonding composition of claim 18, wherein the ceramic bonding composition comprises up to about 10 mole percent silica.

20. The ceramic bonding composition of claim 17, wherein Mc is aluminum.

21. The ceramic bonding composition of claim 20, wherein the total amount of alumina in the ceramic bonding composition is in a range from about 1 mole percent to about 50 mole percent.

22. The ceramic bonding composition of claim 21, wherein the eutectic composition is the first eutectic composition in the alumina rich region.

23. The ceramic bonding composition of claim 22, wherein Me is yttrium.

24. The ceramic bonding composition of claim 22, wherein Me is dysprosium.

25. The ceramic bonding composition of claim 22, wherein Me is a combination of yttrium and dysprosium.

26. An article of manufacture comprising at least two members bonded together with a ceramic bonding composition that comprises alumina and at least another oxide having a formula of Me₂O₃; wherein Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein when Me is other than lanthanum, an amount of the at least another oxide in the ceramic bonding composition satisfies a condition selected from the group consisting of:
(a) when Me is selected from the group consisting of yttrium, dysprosium, holmium, erbium, thulium, ytterbium, lutetium, and combinations thereof, said amount is between about 3 and about 15 mole percent, or between 25 and about 37.5 mole percent; and
(b) when Me is selected from the group consisting of neodymium, samarium, gadolinium, europium, praseodymium, terbium, and combinations thereof, said amount is between about 3 and about 18 mole percent, or between 28 and about 37.5 mole percent.

27. The article of manufacture of claim 26, wherein the article comprises a housing of a discharge lamp.

28. An article of manufacture comprising at least two members bonded together with a ceramic bonding composition that comprises a first oxide, at least a second oxide having a formula of Me₂O₃, and silica; wherein the first oxide is selected from the group consisting of aluminum oxide, scandium oxide, and combinations thereof; Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein the ceramic bonding composition satisfies a condition selected from the group consisting of:
(a) said ceramic bonding composition comprising the first oxide in an amount between about 25 and about 55 weight percent, silica in an amount greater than about 45 weight percent, and Me₂O₃ in an amount less than about 30 weight percent;
(b) said ceramic bonding composition comprising the first oxide in an amount between about 25 and about 90 weight percent, silica in an amount less than about 45 weight percent, and Me₂O₃ in an amount less than about 20 weight percent;
(c) said ceramic bonding composition comprising the first oxide in an amount between about 55 and about 80 weight percent, silica in an amount less than about 30 weight percent, and Me₂O₃ in an amount between about 20 and 55 weight percent; and
(d) said ceramic bonding composition comprising the first oxide in an amount between about 25 and about 55 weight percent, silica in an amount less than about 5 weight percent, and Me₂O₃ in an amount between about 55 and about 70 weight percent.

29. The article of manufacture of claim 28, wherein the article of manufacture comprises a housing of a discharge lamp.

30. An article of manufacture comprising at least two members bonded together with a ceramic bonding composition that comprises a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the oxides form substantially a garnet crystal structure.

31. The article of manufacture of claim 30, wherein the article of manufacture comprises a housing of a discharge lamp.

32. An article of manufacture comprising a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the ceramic bonding composition is in a range from a eutectic composition to a garnet composition.

33. The article of manufacture of claim 32, wherein the article of manufacture comprises a housing of a discharge lamp.

34. A method for bonding together a first work piece and a second work piece, the method comprising:
(a) providing a ceramic bonding composition comprising alumina and at least another oxide having a formula of Me₂O₃; wherein Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein when Me is other than lanthanum, an amount of the at least another oxide in the ceramic bonding composition satisfies a condition selected from the group consisting of:
(1) when Me is selected from the group consisting of yttrium, dysprosium, holmium, erbium, thulium, ytterbium, lutetium, and combinations thereof, said amount is between about 3 and about 15 mole percent, or between 25 and about 37.5 mole percent; and
(2) when Me is selected from the group consisting of neodymium, samarium, gadolinium, europium, praseodymium, terbium, and combinations thereof, said amount is between about 3 and about 18 mole percent, or between 28 and about 37.5 mole percent;
(b) disposing the ceramic bonding composition between a portion of the first work piece and another portion of the second work piece to form an assembly; and
(c) heating the assembly at a predetermined temperature for a predetermine time to bond the first work piece and the second work piece together.

35. The method of claim 34, wherein the step of heating is carried out in a non-oxidizing atmosphere.

36. The method of claim 35, wherein the atmosphere comprises a gas selected from the group consisting of argon, helium, neon, krypton, xenon, hydrogen, nitrogen, and mixtures thereof.

37. The method of claim 34, wherein the step of heating is carried out in a vacuum.

38. The method of claim 34, wherein the predetermined temperature is in a range from about 1500 C to about 1900 C.

39. The method of claim 34, wherein the predetermined temperature is a temperature at which the ceramic bonding composition substantially melts.

40. The method of claim 34, wherein the heating is directed at a joint between the first and the second work piece at which the ceramic bonding composition is disposed.

41. The method according to claim 34, wherein the step of heating is effected by a laser beam.

42. The method according to claim 34, wherein the step of heating is effected by radio frequency waves.

43. A method for bonding together a first work piece and a second work piece, the method comprising:
(a) providing a ceramic bonding composition comprising a first oxide, at least a second oxide having a formula of Me₂O₃, and silica; wherein the first oxide is selected from the group consisting of aluminum oxide, scandium oxide, and combinations thereof; Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein the ceramic bonding composition satisfies a condition selected from the group consisting of:
(1) said ceramic bonding composition comprising the first oxide in an amount between about 25 and about 55 weight percent, silica in an amount greater than about 45 weight percent, and Me₂O₃ in an amount less than about 30 weight percent;
(2) said ceramic bonding composition comprising the first oxide in an amount between about 25 and about 90 weight percent, silica in an amount less than about 45 weight percent, and Me₂O₃ in an amount less than about 20 weight percent;
(3) said ceramic bonding composition comprising the first oxide in an amount between about 55 and about 80 weight percent, silica in an amount less than about 30 weight percent, and Me₂O₃ in an amount between about 20 and 55 weight percent; and
(4) said ceramic bonding composition comprising the first oxide in an amount between about 25 and about 55 weight percent, silica in an amount less than about 5 weight percent, and Me₂O₃ in an amount between about 55 and about 70 weight percent;
(b) disposing the ceramic bonding composition between a portion of the first work piece and another portion of the second work piece to form an assembly; and
(c) heating the assembly at a predetermined temperature for a predetermine time to bond the first work piece and the second work piece together.

44. A method for bonding together a first work piece and a second work piece, the method comprising:
(a) providing a ceramic bonding composition comprising a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the oxides form substantially a garnet crystal structure;
(b) disposing the ceramic bonding composition between a portion of the first work piece and another portion of the second work piece to form an assembly; and
(c) heating the assembly at a predetermined temperature for a predetermine time to bond the first work piece and the second work piece together.

45. A method for bonding together a first work piece and a second work piece, the method comprising:
(a) providing a ceramic bonding composition comprising a first oxide having a formula of Mc₂O₃ and at least a second oxide having a formula of Me₂O₃; wherein Mc is selected from the group consisting of aluminum, scandium, iron, chromium, and combinations thereof; and Me is selected from the group consisting of yttrium, lanthanum, cerium, praseodymium, neodymium, samarium, europium, gadolinium, terbium, dysprosium, holmium, erbium, thulium, ytterbium, lutetium, and combinations thereof; and wherein proportions of the first oxide and the at least a second oxide are selected such that the ceramic bonding composition is in a range from a eutectic composition to a garnet composition;
(b) disposing the ceramic bonding composition between a portion of the first work piece and another portion of the second work piece to form an assembly; and
(c) heating the assembly at a predetermined temperature for a predetermine time to bond the first work piece and the second work piece together.
